(19) United States
(12) Patent Application Publication
(10) Pub. No.: US 2016/0095305 A1
(43) Pub. Date: Apr. 7, 2016

(54) Remotely Controllable Flying Decoy

(71) Applicant: Lumir J. Drahota, Fremont, NE (US)

(72) Inventor: Lumir J. Drahota, Fremont, NE (US)

(21) Appl. No.: 14/873,795

(22) Filed: Oct. 2, 2015

Related U.S. Application Data
(63) Continuation of application No. 62/058,694, filed on Oct. 2, 2014.

(51) Int. Cl. A01M 31/06; B64C 39/02

(52) U.S. Cl. CPC A01M 31/06; B64C 39/024; B64C 2201/12; B64C 2201/108

(57) ABSTRACT

Described and claimed is a decoy assembled from one of multiple bouyant decoy bodies having hinged wings on which one of multiple dressings may be selectably connected, thereby resembling any of a plurality of desired prey, the decoy body being selectably mounted on a propulsion module that may be remotely controlled to exhibit a desired flight pattern.

### REFERENCE TO EARLIER APPLICATION

This Application incorporates by reference and, under 35 U.S.C. §119(e), claims priority to U.S. Provisional Patent Application Ser. No. 62/058,694 filed on Oct. 2, 2014.

### STATEMENT REGARDING FEDERALLY SPONSORED RESEARCH OR DEVELOPMENT

This invention is not the subject of federally sponsored research or development.

### RESERVATION OF COPYRIGHTS

Portions of the disclosure of this document contain material that is subject to copyright protection. The copyright owner has no objection to any reproduction of the document or disclosure as it appears in official records, but reserves all remaining rights under copyright.

### BACKGROUND OF THE INVENTION

Man has hunted animals since the dawn of time. As man has evolved, so have hunting techniques and equipment with increasing success. One significant piece of equipment is the hunting decoy.

Over time, decoys have become more realistic in appearance and behavior. This is partly due to improved dressing techniques and underlying mechanical carriers, which make decoys look and act in a manner that is attractive to the hunter's prey.

While better, most hunting decoys lack realism for lack of imitating true movement, i.e. free flight. Although many birds may initially respond to existing hunting decoys, the unnatural behavior of the decoy becomes obvious and offputting, with the bird eventually losing interest and fleeing. Specifically, decoys presented via a long rod, flown like a kite or motored across an area via a wheel-driven carriage initially may draw the attention of, but then quickly spook, thus not draw into focus desired prey.

What is needed and not taught or suggested in the art is a remotely controllable flying decoy that looks and acts like, therefore attracts a desired prey.

The invention provides improved elements and arrangements thereof, for the purposes described, which are inexpensive, dependable and effective in accomplishing intended purposes of the invention.

Other features and advantages of the invention will become apparent from the following description of the preferred embodiments, which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is a top, front, right side elevational view of an embodiment of a remotely controllable flying decoy configured according to principles of the invention.

FIG. 2 is a plan view of the embodiment of FIG. 1 wherein the body is disassembled from the propulsion module;

FIG. 3 is a plan view of the embodiment of FIG. 1;

FIG. 4 is a top, rear, right side elevational view of the embodiment of FIG. 1;

FIG. 5 is a partial, top, front, right side elevational view of the embodiment of FIG. 1;

FIG. 6 is a top, front, right side elevational view of the embodiment of FIG. 1;

FIG. 7 is a right side elevational view of the embodiment of FIG. 1; and

FIG. 8 is a partial bottom view of the body of the embodiment of FIG. 1.

### DETAILED DESCRIPTION OF THE PREFERRED EMBODIMENTS

This disclosure is not limited in application to the details of construction and the arrangement of components set forth or illustrated in the drawings herein. The disclosure is capable of other embodiments and of being practiced or of being carried out in various ways. Phraseology and terminology used herein is for description and should not be regarded as limiting. Uses of “including,” “comprising” or “having” and variations thereof herein are meant to encompass the items listed thereafter and equivalents thereof as well as additional items. Unless limited otherwise, “connected,” “coupled” and “mounted,” and variations thereof herein are used broadly and encompass direct and indirect connections, couplings, and mountings. “Connected” and “coupled” and variations thereof are not restricted to physical or mechanical or electrical connections or couplings. Furthermore, and as described in subsequent paragraphs, the specific mechanical or electrical configurations described or illustrated are intended to exemplify embodiments of the disclosure. However, alternative mechanical or electrical configurations are possible, which are considered to be within the teachings of the disclosure. Furthermore, unless otherwise indicated, “or” is to be considered inclusive.

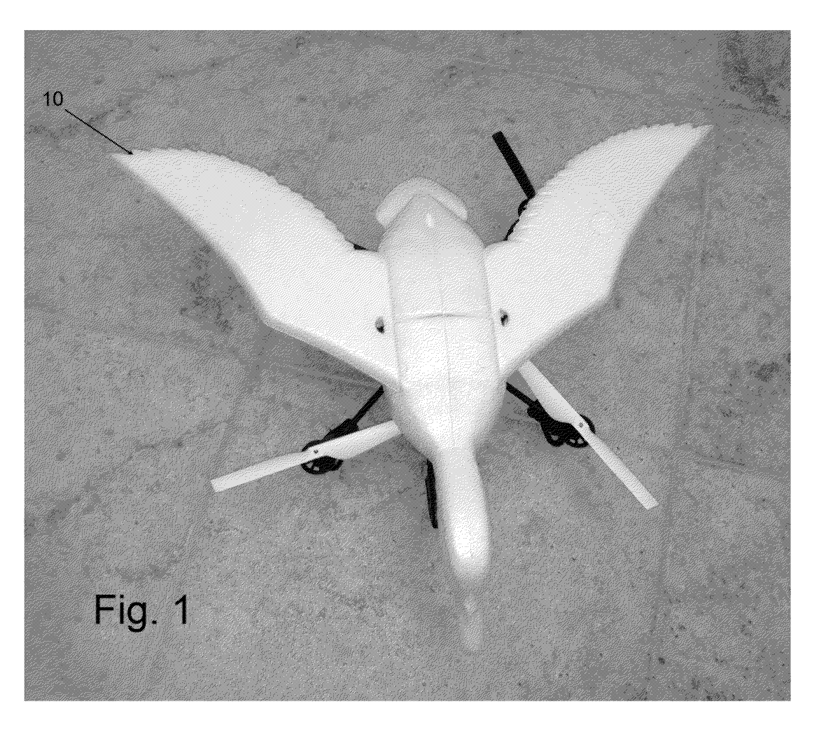

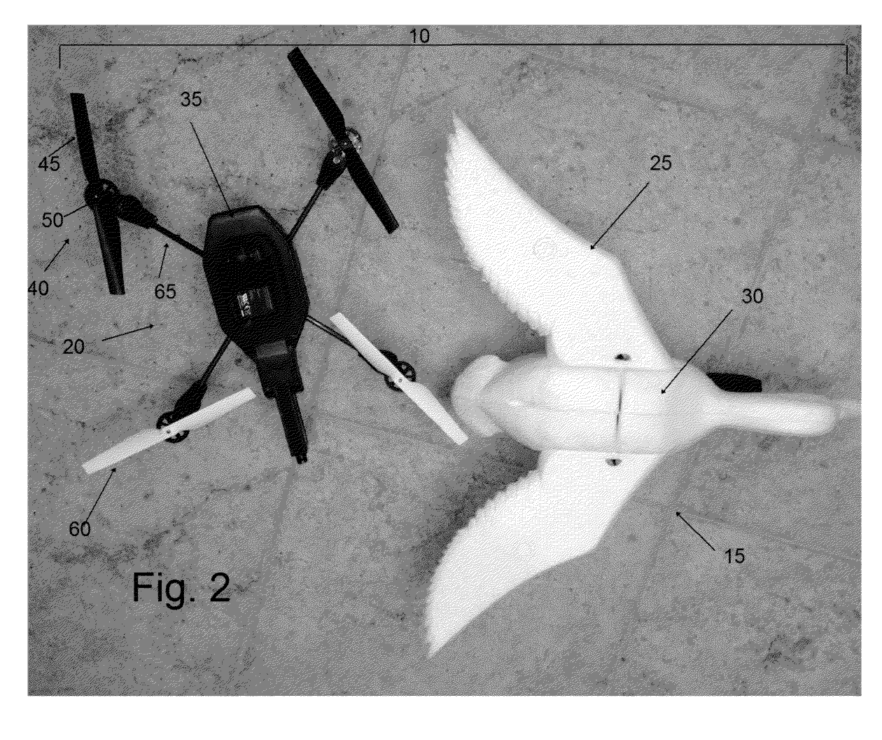

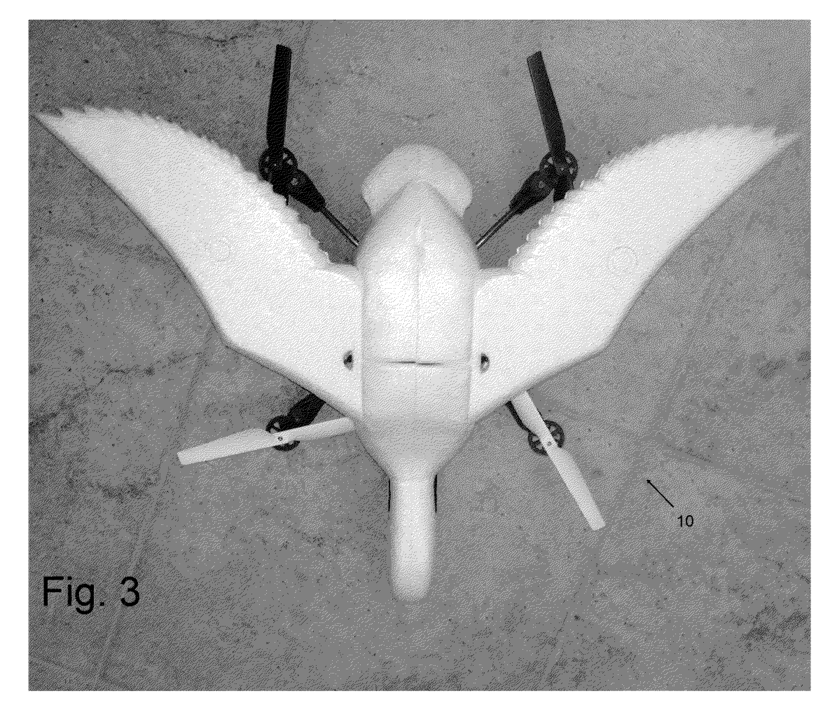

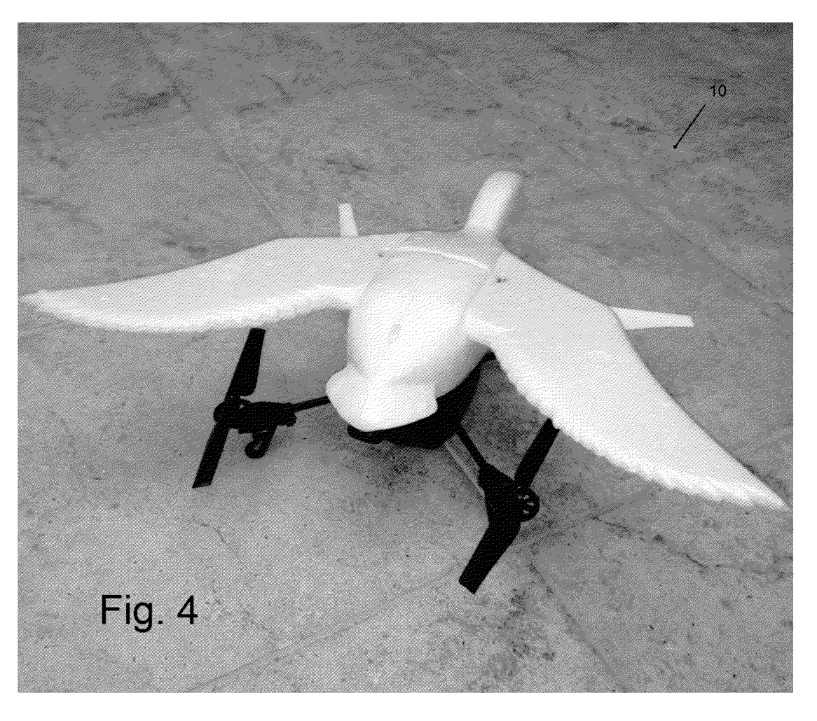

Referring to FIGS. 1-4, the invention is a remotely controllable flying decoy that looks and acts like, and attracts a desired prey. An embodiment of a decoy 10 configured according to principles of the invention includes a body 15 and a detachable propulsion module 20. Detachability of body 15 and propulsion module 20, and the ability to change a dress 90 covering body 15, described in greater detail below, permits altering the appearance of decoy 10 by mounting on propulsion module 20 differently sized, configured and adorned bodies 15.

Body 15 is defined by a torso 30 and wings 25 that are appropriately matched to resemble a bird. Preferably, the invention is intended to employ or be configured to accommodate a plurality of bodies 15, each approximating the shape of any of a variety of birds, such as, but not limited to ducks, geese and partridge.

Torso 30 may be constructed of any material that is appropriate for its intended purpose, but preferably is constructed of closed-cell extruded polystyrene foam, commonly referred to as Styrofoam®, or comparable material. The material increases overall buoyancy of decoy 10 and deters its submersion upon alighting on a pond intentionally or by accident. The material also aids in protecting propulsion module 20 from some impacts should decoy 10 plummet precipitously to the ground.

Wings 25 may be fixed, but preferably are hinged relative to torso 30. Preferably, wings 25 are constructed of a semi-rigid or flexible material, such as thin foam or fabric. The flexibility of the material of wings 25 permits reliance on a “natural hinge,” essentially localized elasticity of the material between wings 25 and torso 30, to promote realistic movement of wings 25 when decoy 10 is in flight. An embodiment of the invention includes a motor or driver (not shown) to induce motion of wings 25 relative to torso 30 in a flapping manner or spinning motion to mimic flapping.

Propulsion module 20, preferably, is a battery-powered, rotor-driven drone with wireless remote controls (not shown). A main compartment 35 houses an electric motor (not shown), battery pack (not shown) and a controller (not shown) having or connected to an antenna (not shown) through which the remote controls communicate instructions.

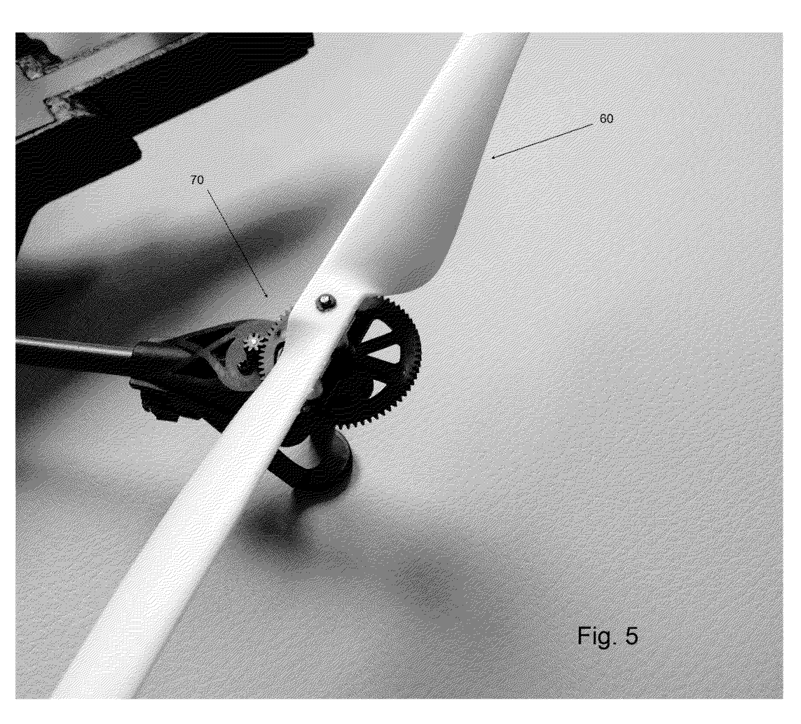

Referring also to FIG. 5, each of four rotors 40 includes bearing-mounted propellers 45, 60 that the motor drives via gears 70. Alternatively, propellers may be fixed to pulleys that are independently belt-driven by the motor. Controlling relative propulsion power of each rotor 40 controls the flight of decoy 10.

Propellers 45, 60 are configured or camouflaged so as not to be apparent to desired prey. To that end, front propellers 60, preferably, are clear or white, while rear propellers 45, preferably, are black. When rotating, front propellers essentially become imperceptible relative to the bright sky, while rear propellers 45 blend in with the black stanchions 65 that support rotors 40 ostensibly imitating feet, such as the black feet of geese.

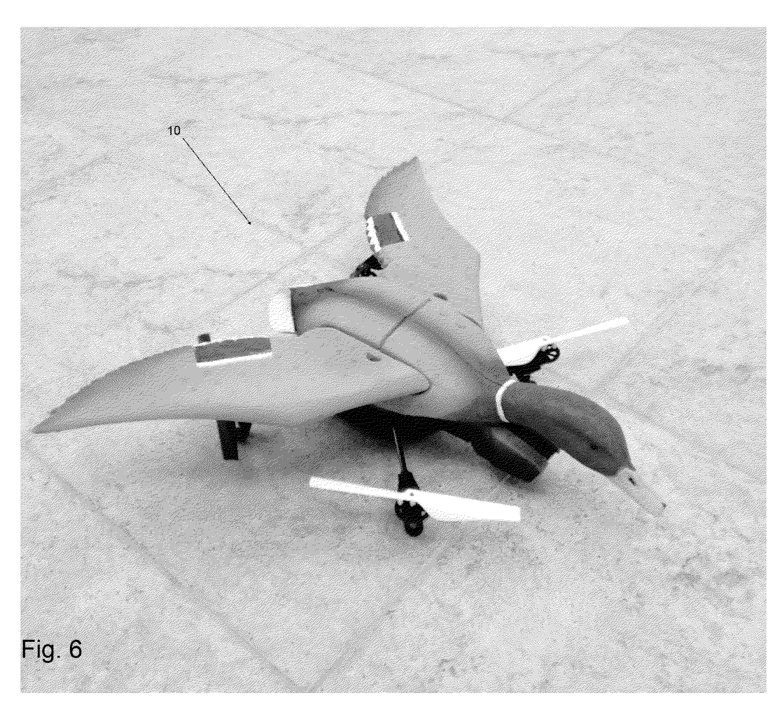

Referring to FIGS. 6-8, decoy 10 is intended for use with essentially all types of winged prey. Therefore, commensurate with the different body portions that may be assembled with propulsion module 20, body 15 may be configured, colored, appliqued or otherwise adorned so as to imitate the body configurations and colorations of desired prey.

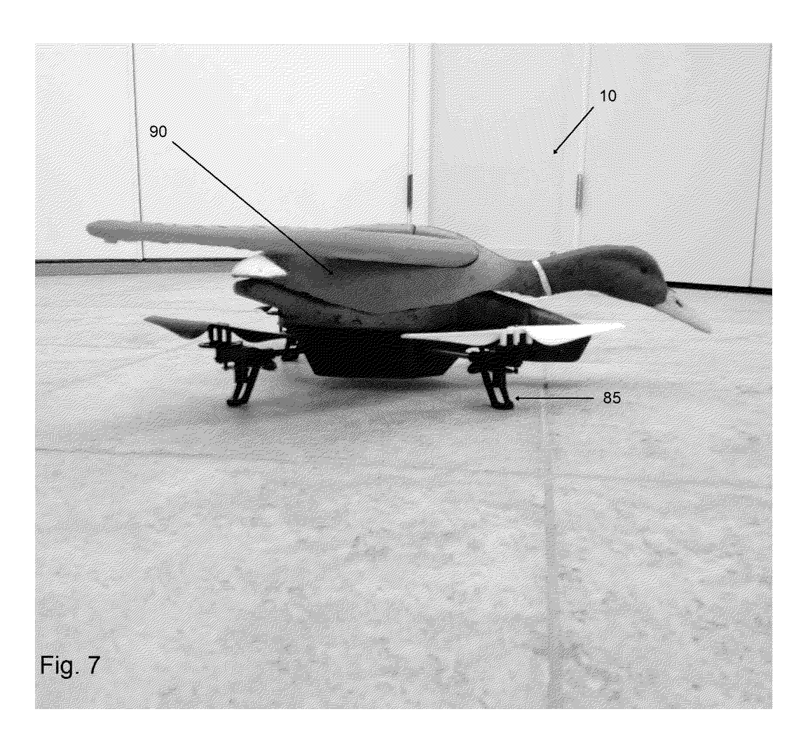

Referring to FIG. 7, decoy 10 is provided with a dress 90 that is appropriate for the configuration of body 15 and wings 25 and cooperates therewith to give decoy 10 and overall appearance of resembling that which would attract a desired prey. Dress 90 should be understood broadly, including, but not limited to paint, as shown, appliques, feathers and/or covers constructed of fabric, plastic or other materials suitable for the purposed described herein. Embodiments of dress 90 that are not self-adherent may be mounted on body 15 and/or wings 25 with, but not limited to, glue, hook-and-loop fasteners, ties or other appropriate mounting convention.

Decoy 10 also has legs 85 for maintaining decoy 10 in a stable fashion on a surface or the ground when not flying. An alternative embodiment of the invention employs legs (not shown) constructed of or connected to buoyant material or otherwise configured to provide buoyancy. Another embodiment of the invention employs legs (not shown) that are elongated or otherwise suited for positioning decoy 10 above the ground and above potentially fouling elements, such as long grasses and corn stalks.

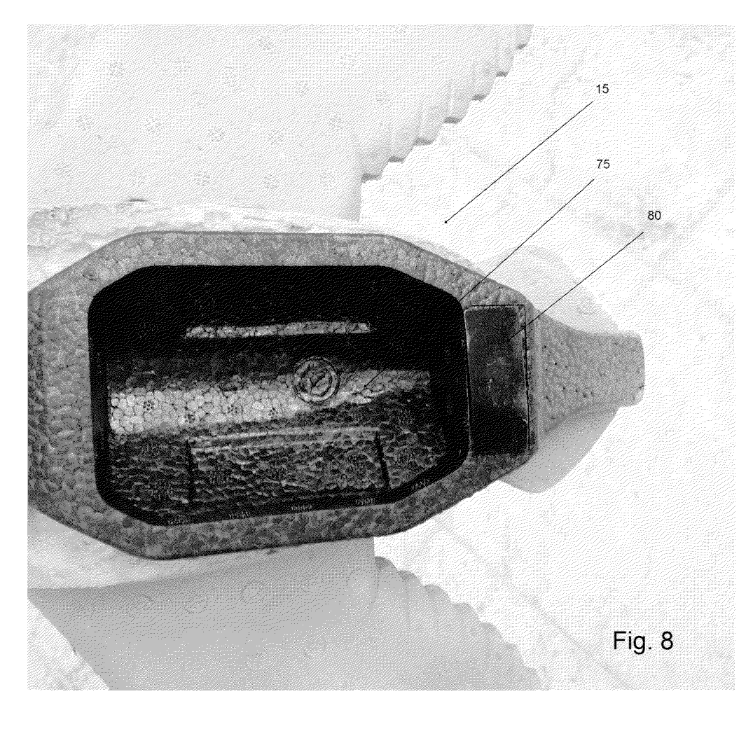

Referring also to FIG. 8, body 15, preferably, defines a cavity 75 for receiving main compartment 35 of propulsion module 20. Body 15 also may include a magnet 80 for securing body 15 to main compartment 35. Rather than a magnetic attraction, other fastening conventions are contemplated, such as hook-and-loop fasteners, commonly referred to as velcro®, or the like.

Another embodiment of decoy 10 configured according to principles of the invention includes a controller (not shown) for controlling the flight of decoy 10 according to a set of instructions stored in a memory that controller (not shown) can access. Controller (not shown) may be connected with or include an antenna or other communication equipment (not shown) appropriate for maintaining, accessing or navigating according to a global positioning system (GPS).

A further embodiment of decoy 10 configured according to principles of the invention includes a controller (not shown) that is configured or connected with appropriate communication equipment (not shown) to communicate with other decoys 10. Such communication may include instructing the other decoys 10 to fly according to a set of instructions stored in a memory that controller (not shown) can access. The instruction of multiple decoys 10 may provide for a coordinated flight pattern that simulates the flight of, for example, a flock of ducks.

The invention is not limited to the particular embodiments described and depicted herein, rather only to the following claims.

I claim:

1. Remote control decoy apparatus comprising:
a propulsion module configured to enable flight of said apparatus;
a torso configured to have an appearance resembling a bird detachably mounted on said propulsion module; and
a controller configured to:
receive and respond to a signal; and
control propulsion module so that said apparatus exhibits a flight pattern corresponding to the signal.

2. Apparatus of claim 1, further comprising a wing mounted on said torso.

3. Apparatus of claim 2, further comprising a dress mounted on said wing.

4. Apparatus of claim 2, further comprising a driver configured to move said wing relative to said body.

5. Apparatus of claim 4, wherein said controller is configured to control said driver so that said wing exhibits movement corresponding to the signal.

6. Apparatus of claim 1, further comprising a dress mounted on said torso.

7. Apparatus of claim 1, wherein said torso is configured and/or constructed of a material that renders said apparatus buoyant.

8. Apparatus of claim 1, wherein said propulsion module comprises a motor, wherein said torso is configured to protect said motor and/or said controller from impact.

9. Apparatus of claim 1, further comprising a leg configured to maintain said apparatus at a predetermined height relative to the ground.

10. Apparatus of claim 1, wherein said propulsion module comprises a propeller that is camouflaged.

11. Apparatus of claim 1, wherein said controller is configured to transmit a signal.
